(19) United States
(12) Patent Application Publication
(10) Pub. No.: US 2023/0246263 A1
(43) Pub. Date: Aug. 3, 2023

(54) COOLING JACKET ASSEMBLY AND MANUFACTURING METHODS THEREOF

(71) Applicant: ELECTRIC POWER SYSTEMS, INC., North Logan, UT (US)

(72) Inventors: Jacob Bowman, North Logan, UT (US); Cory Newman, Smithfield, UT (US)

(73) Assignee: ELECTRIC POWER SYSTEMS, INC., North Logan, UT (US)

(21) Appl. No.: 18/008,131

(22) PCT Filed: Jun. 4, 2021
(86) PCT No.: PCT/US2021/036032

§ 371 Date: Dec. 2, 2022

Related U.S. Application Data
(60) Provisional application No. 63/038,435, filed on Jun. 12, 2020.

(51) Int. Cl. H01M 10/6556; H01M 50/209; H01M 10/613

(52) U.S. Cl. CPC H01M 10/6556; H01M 50/209; H01M 10/613

(57) ABSTRACT

A cooling jacket assembly includes an inner housing and an outer housing. The inner housing is disposed within the outer housing. The inner housing and the outer housing define fluid channels therebetween. The inner housing is configured to receive a cell array therein. The inner housing is coupled to the outer housing. The cooling jacket assembly is configured to transfer heat from a heat transfer fluid through the inner housing to the cell array.

### FIELD OF INVENTION

The present disclosure generally relates to a cooling jacket assembly for use in a battery module.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A battery module, for purposes of this disclosure, includes a plurality of electrically connected cell-brick assemblies. These cell-brick assemblies may, in turn, include a parallel, series, or combination of both, collection of electrochemical or electrostatic cells hereafter referred to collectively as “cells”, that can be charged electrically to provide a static potential for power or released electrical charge when needed. When cells are assembled into a battery module, the cells are often linked together through metal strips, straps, wires, bus bars, etc., that are welded, soldered, or otherwise fastened to each cell to link them together in the desired configuration.

A cell may be comprised of at least one positive electrode and at least one negative electrode. One common form of such a cell is the well-known secondary cells packaged in a cylindrical metal can, a pouch cell, or in a prismatic case. Examples of chemistry used in such secondary cells are Lithium Titanate Oxide (LTO), lithium cobalt oxide, lithium manganese, lithium iron phosphate, nickel cadmium, nickel zinc, and nickel metal hydride. Such cells are mass produced, driven by an ever-increasing consumer market that demands low cost rechargeable energy.

Liquid cooling of cell-brick assemblies is not typically utilized due to various risks associated therewith. Additionally, designing a cooling system for a cell-brick assembly may be expensive to manufacture relative to typical cooling methods for cell-brick assemblies. Accordingly, new cooling systems for a cell-brick assembly utilizing a safe, cost-effective and manufacturable assembly may be desirable.

### SUMMARY OF THE INVENTION

A cooling jacket assembly is disclosed herein. The cooling jacket assembly may comprise: an inner housing, comprising: a first inner end wall, a second inner end wall disposed opposite the first inner end wall, a first inner sidewall extending from the first inner end wall to the second inner end wall, a second inner sidewall extending form the first inner end wall to the second inner end wall, the second inner sidewall disposed opposite the first inner sidewall, and a bottom inner wall disposed along a bottom inner end of the first inner end wall, the second inner end wall, the first inner sidewall and the second inner sidewall; and an outer housing, comprising: a first outer end wall, the first outer end wall and the first inner end wall defining a first end wall channel therebetween, a second outer end wall disposed opposite the first outer end wall, the second outer end wall and the second inner end wall defining a second end wall channel therebetween, a first outer sidewall extending from the first outer end wall to the second outer end wall, the first outer sidewall and the first inner sidewall defining a first sidewall channel therebetween, a second outer sidewall extending form the first outer end wall to the second outer end wall, the second outer sidewall disposed opposite the first outer sidewall, the second outer sidewall and the second inner sidewall defining a second sidewall channel therebetween, and a bottom outer wall disposed along a bottom outer end of the first outer end wall, the second outer end wall, the first outer sidewall and the second outer sidewall, the bottom outer wall coupled to the bottom inner wall.

In various embodiments, the inner housing further comprises a flange coupled to a distal end of the first outer end wall, the second outer end wall, the first outer sidewall, and the second outer sidewall. The flange may further comprise a first aperture and a second aperture, the first aperture in fluid communication with the first end wall channel. The second aperture may be in fluid communication with the second end wall channel. A first fluid port may be coupled to the first aperture and a second fluid port may be coupled to the second aperture. The cooling jacket assembly may further comprise a wall extending between the first inner end wall and the first outer end wall, wherein the first end wall channel is disposed proximate the first sidewall channel, and wherein a third end wall channel is disposed proximate the second sidewall channel. The cooling jacket assembly may further comprise a first fluid port in fluid communication with the first end wall channel and a second fluid port in fluid communication with the second end wall channel.

A battery module is disclosed herein. The battery module may comprise: a cell array; and a cooling jacket assembly comprising an inner housing and an outer housing, wherein: the inner housing defines an inner cavity and the outer housing defining an outer cavity; the cell array is disposed in the inner cavity; the inner housing is disposed in the outer cavity; inner sidewalls of the inner housing and outer sidewalls of the outer housing define a channel therebetween; a bottom inner wall of the inner housing is coupled to a bottom outer wall of the outer housing; and the channel is configured to receive a heat transfer fluid to transfer heat to the cell array.

In various embodiments, the inner housing may further comprise a flange extending outward from the inner sidewalls away from the inner cavity past the outer sidewalls. The outer sidewalls may be coupled to the flange. The channel may include a first end channel disposed at a first end of the cooling jacket assembly and a second end channel disposed at a second end of the cooling jacket assembly, the first end channel in fluid communication with a first fluid port and the second end channel in fluid communication with a second fluid port. The channel may include a first end channel disposed at a first end of the cooling jacket assembly and a second end channel disposed at the first end of the cooling jacket assembly, the first end channel and the second end channel separated by a wall disposed between the outer sidewalls and the inner sidewalls, the first end channel in fluid communication with a first fluid port and the second end channel in fluid communication with a second fluid port. The bottom outer wall and the bottom inner wall may be configured to transfer heat from the cell array via conduction. The battery module may further comprise a first fluid port and a second fluid port in fluid communication with the channel.

A method of manufacturing a cooling jacket assembly is disclosed herein. The method may comprise: disposing an inner housing within an outer housing, the inner housing including inner sidewalls defining an inner cavity and a flange extending away from the inner cavity at an inner top end of the inner sidewalls; coupling an outer bottom wall of the outer housing to an inner bottom wall of the inner housing, the outer housing including outer sidewalls; and coupling the flange to an outer top end of the outer sidewalls.

In various embodiments, the method further comprises deep drawing or bending a first sheet metal to form the outer housing. The method may further comprise deep drawing or bending a second sheet metal to form the inner housing. The method may further comprise coupling a first fluid port and a second fluid port to the cooling jacket assembly, the first fluid port and the second fluid port in fluid communication with a channel defined by the outer sidewalls and the inner sidewalls. Coupling the outer bottom wall to the inner bottom wall may include welding. Coupling the flange to the outer sidewalls may include welding.

The foregoing features and elements may be combined in various combinations without exclusivity, unless expressly indicated otherwise. These features and elements as well as the operation thereof will become more apparent in light of the following description and the accompanying drawings. It should be understood; however, the following description and drawings are intended to be exemplary in nature and non-limiting. The contents of this section are intended as a simplified introduction to the disclosure and are not intended to limit the scope of any claim.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and where:

FIG. 1 illustrates an exploded perspective view of a battery module, in accordance with various embodiments;

FIG. 2 illustrates a cross-sectional view of a cooling jacket assembly, in accordance with various embodiments;

FIG. 3 illustrates a cross-sectional view of a cooling jacket assembly, in accordance with various embodiments;

FIG. 4 illustrates an exploded perspective view of a cooling jacket assembly, in accordance with various embodiments;

FIG. 5 illustrates a cross-sectional view of a cooling jacket assembly, in accordance with various embodiments;

FIG. 6 illustrates a bottom view of a cooling jacket assembly, in accordance with various embodiments; and

FIG. 7 illustrates a method of manufacturing a cooling jacket assembly, in accordance with various embodiments.

### DETAILED DESCRIPTION

The following description is of various example embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments, without departing from the scope of the appended claims. For example, the steps recited in any of the method or process descriptions may be executed in any order and are not necessarily limited to the order presented. Moreover, many of the manufacturing functions or steps may be outsourced to or performed by one or more third parties. Furthermore, any reference to singular includes plural embodiments, and any reference to more than one component or step may include a singular embodiment or step. Also, any reference to attached, fixed, connected or the like may include permanent, removable, temporary, partial, full and/or any other possible attachment option. As used herein, the terms “coupled,” “coupling,” or any other variation thereof, are intended to cover a physical connection, an electrical connection, a magnetic connection, an optical connection, a communicative connection, a functional connection, and/or any other connection.

For the sake of brevity, conventional techniques for mechanical system construction, management, operation, measurement, optimization, and/or control, as well as conventional techniques for mechanical power transfer, modulation, control, and/or use, may not be described in detail herein. Furthermore, the connecting lines shown in various figures contained herein are intended to represent example functional relationships and/or physical couplings between various elements. It should be noted that many alternative or additional functional relationships or physical connections may be present in a modular structure.

In various embodiments, a cooling jacket assembly may comprise an outer housing and an inner housing. The outer housing may be coupled to the inner housing by any method known in the art, such as welding, brazing, or the like. In various embodiments, the outer housing and the inner housing may define a cooling channel therein. The cooling channel may extend from a first end to a second end. In various embodiments, the cooling channel may be a split cooling channel where a cooling fluid splits into two paths (i.e., a first cooling path on a first side of the cooling jacket assembly and/or a second cooling path on a second side of the cooling jacket assembly). In various embodiments, the cooling channel may extend from an inlet on a first end of the cooling jacket assembly to an outlet on a second end of the cooling jacket assembly. In various embodiments, the cooling channel may begin and end at a first end of the cooling jacket assembly. For example, a fluid may enter an inlet at a first end of the cooling jacket assembly, travel around a perimeter of the cooling jacket assembly, and exit an outlet at the first end of the cooling jacket assembly.

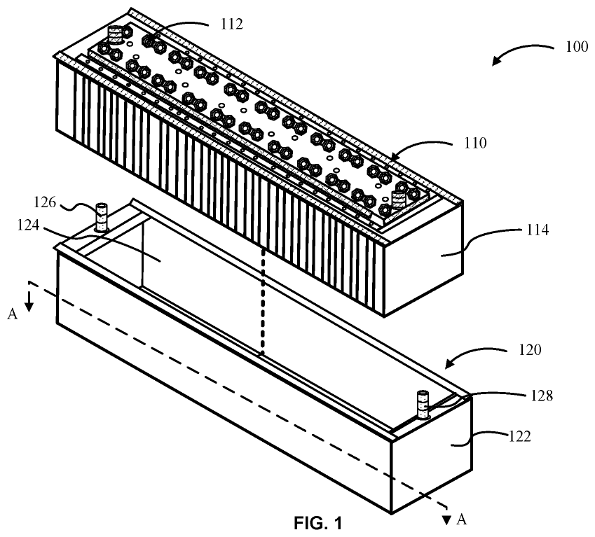

Referring now to FIG. 1, a perspective exploded view of a battery module, in accordance with various embodiments, is illustrated. The battery module 100 includes a cell array 110 and a cooling jacket assembly 120. Although battery module 100 is illustrated as including a cell array 110 with a plurality of prismatic cells 112, any cell array is within the scope of this disclosure. For example, the cell array 110 could include pouch cells, cylindrical cells, or the like. The cell array 110 may be disposed within a potting component 114. The potting component 114 is configured to interface with the cooling jacket assembly 120. In various embodiments, the potting component 114 may comprise a thermally conductive material but not electrically conductive. For example, the potting component 114 may comprise a thermoplastic elastomer, silicone, silicone rubber, natural rubber, or the like. In an example embodiment, the potting component 114 comprises silicon. Moreover, any suitable thermally conductive material and non-electrically conductive material may be used for potting component 114.

In accordance with various embodiments, the potting component 114 is configured to surround the cells 112 on all sides. In various embodiments, the potting component 114 is configured to surround the cells on the bottom as well.

In various embodiments, the cooling jacket assembly 120 comprises an outer housing 122, an inner housing 124, a first fluid port 126, and a second fluid port 128. The outer housing 122 may comprise a substantially rectangular prismatic shape. The outer housing 122 is configured to receive the inner housing 124 therein. In this regard, walls of the outer housing 122 and the inner housing 124 may define a cooling channel therethrough. The cooling channel may be in fluid communication with the first fluid port 126 and the second fluid port 128. In various embodiments, the cooling channel may run along one or both sides of the cooling jacket assembly and transfer heat to the inner housing 124 from the cell array 110 via the potting component 114 of the cell array.

In various embodiments, the inner housing 124 is configured to interface with the potting component 114 of cell array 110. In various embodiments, the inner housing 124 may comprise a thermally conductive material, such as aluminum, tungsten, nickel, copper, beryllium, silver, gold, rhodium, silicon or any other thermally conductive material known in the art. In an example embodiment, the inner housing 124 comprises aluminum. In various embodiments, the inner housing 124 may comprise any thermally conductive material known in the art, such as a material with a thermal conductivity greater than

$$50 \frac{W}{m * K} ( \frac{BTU}{ft * hr * F} ) ,$$

or preferably greater than

$$100 \frac{W}{m * K} ( \frac{B T U}{ft * hr * F} ) .$$

Moreover, any suitable thermally conductive material may be used for inner housing 124. In various embodiments, the outer housing 122 may be made in accordance with the inner housing 124. In various embodiments, heat may be transferred from the cell array 110 through the potting component 114 and inner housing 124 to a heat transfer fluid disposed therein. In this regard, the outer housing 122 may be coupled to the inner housing 124 by any manufacturing method known in the art, such as welding, brazing, or the like.

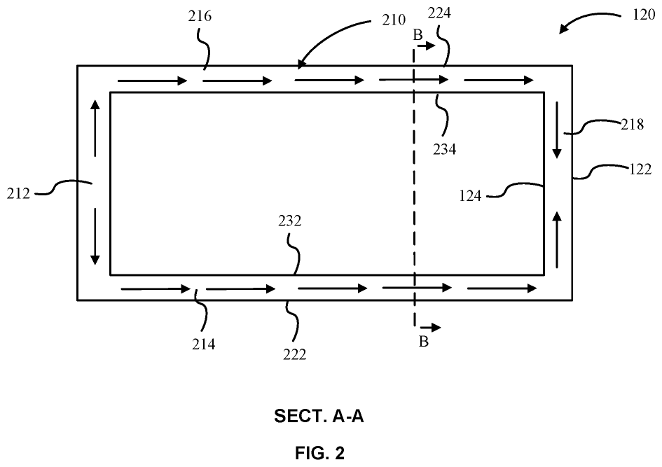

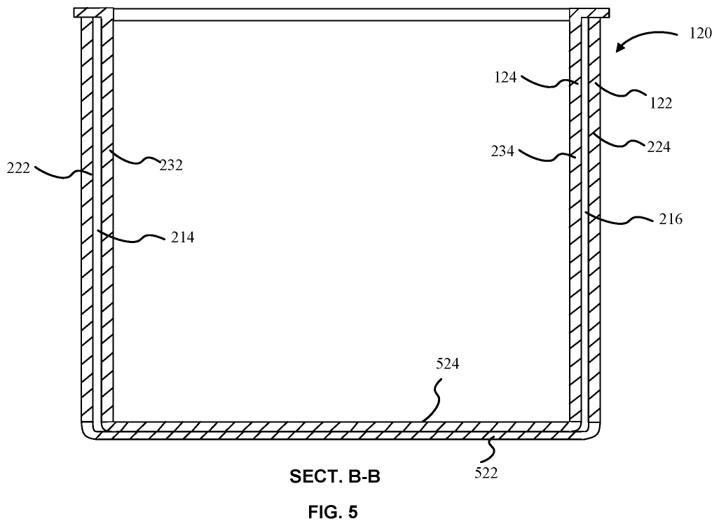

Referring now to FIG. 2, a cross-sectional view of cooling jacket assembly 120 along section line A-A from FIG. 1, in accordance with various embodiments, is illustrated. With combined reference to FIGS. 1 and 2, a heat transfer fluid is configured to enter first fluid port 126 into a cooling channel 210 defined by the outer housing 122 and the inner housing 124 at a first end 212 of the cooling channel 210. In various embodiments, the heat transfer fluid may split in two directions upon entering the first fluid port 126 to a first side channel 214 and a second side channel 216. The first side channel 214 is defined by a first sidewall 222 of the outer housing 122 and a first sidewall 232 of the inner housing 124. Similarly, the second side channel 216 is defined by a second sidewall 224 of the outer housing 122 and a second sidewall 234 of the inner housing 124. In various embodiments, the heat transfer fluid is configured to exit the second fluid port 128. In this regard, the heat transfer fluid may constantly be cycled through the cooling jacket assembly 120 to cool the cell array 110. Although illustrated as having the first fluid port 126 at the first end 212 and the second fluid port 128 at the second end 218 of the cooling channel 210, one skilled in the art may appreciate any number of configurations for a cooling channel is within the scope of this disclosure. Although illustrated as having only side channels (e.g., side channels 214, 216) the cooling jacket assembly 120 may include a bottom channel. For example, with brief reference to FIG. 5, an outer bottom wall 522 of outer housing 122 and inner bottom wall 524 of inner housing 124 may be separated, but the bottom walls 522, 524 may remain coupled together by stand-off components, columns, posts, or the like.

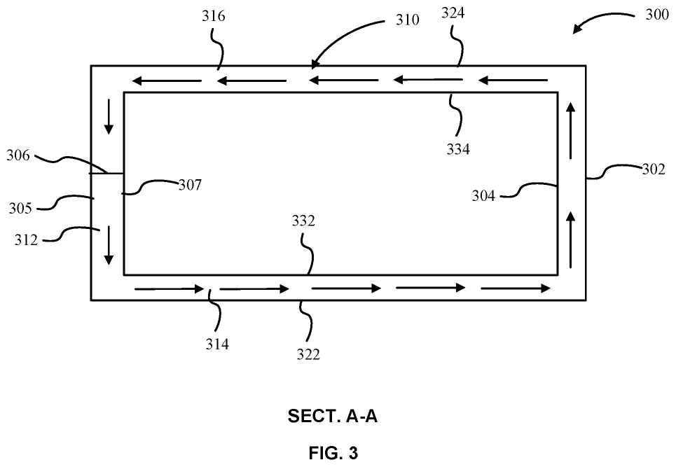

With reference now to FIG. 3, in accordance with another example embodiment, a cooling channel 310 of a cooling jacket assembly 300 is illustrated. In various embodiments, a wall 306 may be disposed between a first end wall 305 of the outer housing 302 and a first end wall 307 of the inner housing 304 proximate a first end 312 of the cooling channel 310. In this regard, fluid may enter a first fluid port in accordance with the first fluid port 126 from FIG. 1 proximate the first end 312 on a first side of the cooling jacket assembly 300 and run along a first side channel 214 around an end channel 303, back along a second side channel 216 and exit through a second fluid port in accordance with the second fluid port 128 from FIG. 1 proximate the first end 312 on a second side of the cooling jacket assembly 300 (i.e., opposite the wall 306). In another example embodiment, not shown, the cooling jacket assembly may comprise two independent cooling channels, one for each side, and comprising an input/output port pair for each side.

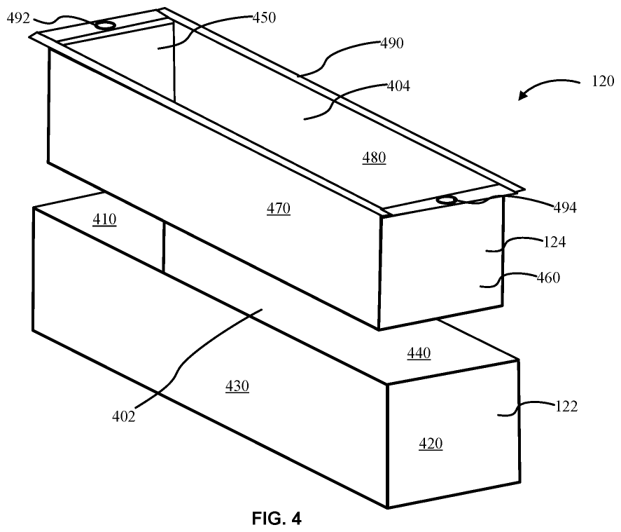

Referring now to FIG. 4, an exploded perspective view of a cooling jacket assembly 120, in accordance with various embodiments, is illustrated. The cooling jacket assembly 120 comprises the outer housing 122 and the inner housing 124. In various embodiments, the outer housing 122 comprises a first end wall 410, a second end wall 420, a first sidewall 222 and a second sidewall 224. The first end wall 410 is disposed opposite the second end wall 420. Similarly, the first sidewall 222 is disposed opposite the second sidewall 224. The first sidewall 222 extends from a first side of first end wall 410 to a first side of second end wall 420. Similarly, the second sidewall 224 extends from a second side of first end wall 410 to a second side of a second end wall 420. In an example embodiment, the first sidewall 222 and the second sidewall 224 may be substantially longer than the first end wall 410 and the second end wall 420. In this regard, the outer housing 122 may comprise a substantially rectangular prismatic shape.

Similarly, in various embodiments, the inner housing 124 comprises a first end wall 450, a second end wall 460, a first sidewall 232 and a second sidewall 234. The first end wall 450 is disposed opposite the second end wall 460. Similarly, the first sidewall 232 is disposed opposite the second sidewall 234. The first sidewall 232 extends from a first side of first end wall 450 to a first side of second end wall 460. Similarly, the second sidewall 234 extends from a second side of first end wall 450 to a second side of a second end wall 460. The first sidewall 232 and the second sidewall 234 may be substantially longer than the first end wall 450 and the second end wall 460. In this regard, the inner housing 124 may comprise a substantially rectangular prismatic shape.

In various embodiments, the first end wall 450, the first sidewall 232, the second end wall 460, and the second sidewall 234 of the inner housing 124 define a cavity 404 within the cooling jacket assembly 120. The cavity 404 is configured to receive a cell array (e.g., cell array 110 from FIG. 1). In various embodiments, the inner housing 124 further comprises a flange 490 extending around a perimeter of a top surface of the first end wall 450, the first sidewall 232, the second end wall 460, and the second sidewall 234. Alternatively, in another example embodiment, the outer housing 122 comprises the flange extending around a perimeter of a top surface of the of the first end wall 410, the first sidewall 222, the second end wall 420, and the second sidewall 224, and the flange is coupled to the inner housing 124. As such, the disclosure is not limited in this regard.

In various embodiments, the first end wall 410, the first sidewall 222, the second end wall 420, and the second sidewall 224 define a cavity 402 in the outer housing 122. In various embodiments, the first end wall 450, the first sidewall 232, the second end wall 460, and the second sidewall 234 of the inner housing 124 may be disposed within the cavity 402 of the outer housing 122. In various embodiments, the flange 490 may extend outward from the cavity 404 past the first end wall 410, the first sidewall 222, the second end wall 420, and the second sidewall 224 of the outer housing 122. In this regard, the flange 490 may be configured to be coupled to the outer housing at an interface between the first end wall 410, the first sidewall 222, the second end wall 420, and the second sidewall 224 and a bottom surface of the flange 490.

In various embodiments, the flange 490 comprises a first aperture 492 disposed proximate the first end wall 450 and a second aperture 494 disposed proximate the second end wall 460. Although illustrated as comprising the first aperture 492 proximate the first end wall 450 and the second aperture 494 proximate the second end wall 460, the disclosure is not limited in this regard. For example, the first aperture 492 and the second aperture 494 may be disposed at the same end. One skilled in the art may recognize various locations for which the first aperture 492 and the second aperture 494 may be disposed; thus, the disclosure is not limited in this regard. In various embodiments, the first aperture 492 is configured to receive a first fluid port (e.g., first fluid port 126 from FIG. 1) and the second aperture 494 is configured to receive a second fluid port (e.g., second fluid port 128 from FIG. 1). In various embodiments, the first fluid port and the second fluid port may be sealed to prevent fluid from leaking during use of the cooling jacket assembly 120.

In various embodiments, the inner housing 124 and the outer housing 122 may be manufactured by any method known in the art. For example, the inner housing 124 and the outer housing 122 may be sheet metal bent parts, deep drawn metal, or the like. Bending sheet metal parts or deep drawing metal parts is an inexpensive process and may result in a cheaper cooling system for a cell array (e.g., cell array 110 from FIG. 1) relative to typical cooling systems for cell arrays.

Referring now to FIG. 5, a cross-sectional view of a cooling jacket assembly 120 along section line B-B from FIG. 2 is illustrated, in accordance with various embodiments. In various embodiments, the outer housing 122 further comprises an outer bottom wall 522 and the inner housing 124 further comprises a inner bottom wall 524. In various embodiments, the cooling channels extend only between sidewalls and not between a bottom wall. For example, the first side channel 214 extends between the first sidewall 222 of the outer housing 122 and the first sidewall 232 of the inner housing 124 and the second side channel 216 extends between the second sidewall 224 of the outer housing 122 and the second sidewall 234 of the inner housing 124. In contrast, the outer bottom wall 522 of the outer housing 122 may be coupled to the inner bottom wall 524 of the inner housing 124. In this regard, the outer bottom wall 522 of the outer housing 122 and the inner bottom wall 524 of the inner housing 124 act as a heating pipe during cooling of a respective cell array (e.g., cell array 110 from FIG. 1). For example, heat may be transferred from the cell array through the inner bottom wall 524 of the inner housing 124 and the outer bottom wall 522 of the outer housing 122 through conduction while heat is transferred to the heat-transfer fluid through the first sidewall 232 and the second sidewall 234 of the inner housing 124 from the cell array (e.g., cell array 110 from FIG. 1).

In various embodiments, by coupling the outer bottom wall 522 of the outer housing 122 to the inner bottom wall 524 of the inner housing, the cooling jacket assembly 120 may be prevented from cracking due to shock and/or vibration during operation of the cooling system. For example, if the outer bottom wall 522 of the outer housing 122 and the inner bottom wall 524 of the inner housing were separated, any vibration or shock of the cooling jacket assembly may go directly to the coupling location of the inner housing 124 to the outer housing 122 (e.g., the flange 490 to walls coupling). Additionally, in various embodiments, by having coolant flow only between the end walls and the sidewalls, a coolant volume may be reduced resulting in a reduced weight of a battery module (e.g., battery module 100 from FIG. 1). In an alternative embodiment, the inner housing 124 may not include a bottom wall, and the sidewalls and end walls may be directly welded to the outer bottom wall 522 of the outer housing 122.

In various embodiments, the sidewalls and the end walls of the outer housing 122 may be coupled to the flange 490 of the inner housing 124 by any method known in the art. For example, the first sidewall 222 and the second sidewall 224 of the outer housing 122 may be coupled to the flange 490 at an end distal to the outer bottom wall 522 of the outer housing 122. In various embodiments, the interface may be coupled together through roll welding, or the like. In various embodiments, by coupling the flange 490 of the inner housing 124 and the sidewalls and end walls of the outer housing 122 together and coupling the outer bottom wall 522 of the outer housing 122 and the inner bottom wall 524 of the inner housing 124, the fluid channels (e.g., first side channel 214 and second side channel 216) are sealed from the external environment.

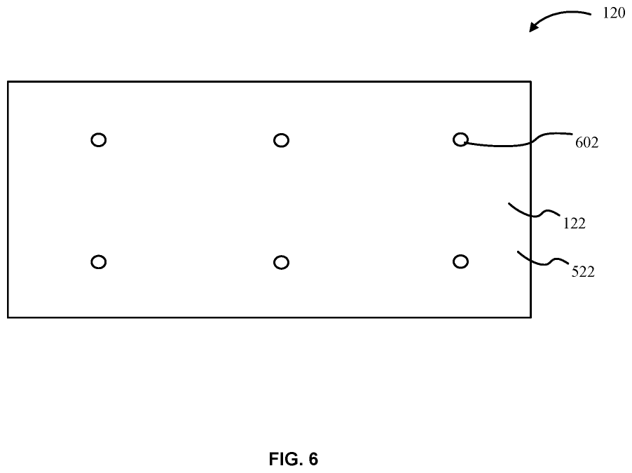

Referring now to FIG. 6, a bottom view of a cooling jacket assembly 120, in accordance with various embodiments, is illustrated. In various embodiments, the outer bottom wall 522 of the outer housing 122 may be coupled to the bottom wall of the inner housing (e.g., inner bottom wall 524 from FIG. 5) by any method known in the art, such as fillet welding, plug welding, or the like. In various embodiments, the outer bottom wall 522 of the outer housing 122 comprises a plurality of apertures 602. The plurality of apertures 602 allow for the outer bottom wall 522 of the outer housing 122 to be coupled to the inner housing (e.g., inner housing 124 from FIG. 5) via a fillet weld or the like. Although described herein with respect to fillet welding or plug welding, any method of coupling a bottom wall of an inner housing to an outer housing is within the scope of this disclosure.

In an alternative embodiment, the inner housing and the outer housing of a respective cooling jacket assembly may be a monolithic component. For example, the inner housing and the outer housing may be manufactured via additive manufacturing, or the like.

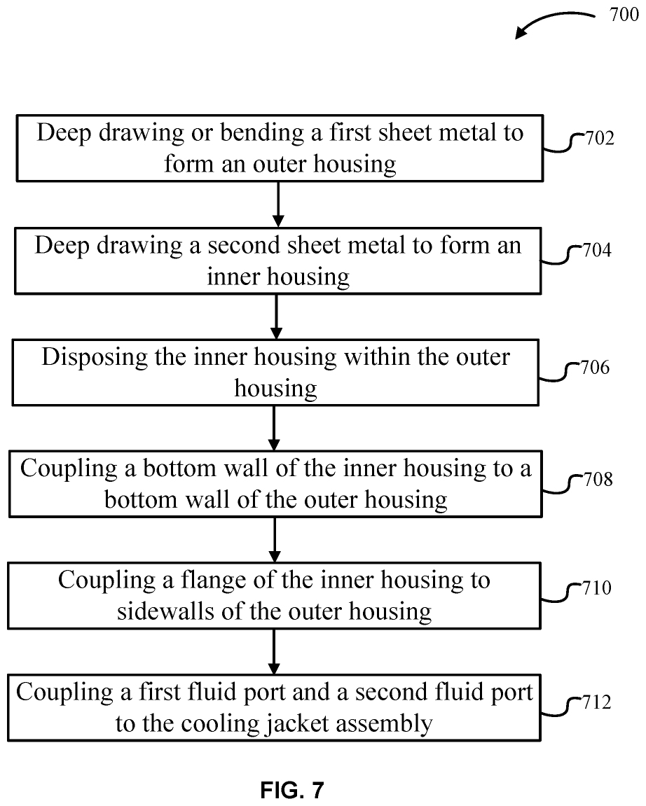

Referring now to FIG. 7, a method 700 of manufacturing a cooling jacket assembly is illustrated, in accordance with various embodiments. The method 700 comprises deep drawing or bending a first sheet metal to form an outer housing (step 702). The outer housing may be in accordance with outer housing 122 as shown in FIGS. 1-2 and 4-6. The method 700 further comprises deep drawing or bending a second sheet metal to form an inner housing (step 704). The inner housing may be in accordance with inner housing 124 as shown in FIGS. 1-2 and 4-5.

The method 700 further comprises disposing the inner housing within the outer housing (step 706). The method 700 further comprises coupling a bottom wall of the inner housing to a bottom wall of the outer housing (step 708). The bottom wall of the inner housing and the bottom wall of the outer housing may be coupled together by any method known in the art, such as a fillet weld, a plug weld, or the like.

The method 700 further comprises coupling a flange of the inner housing to sidewalls and end walls of the outer housing (step 710). The flange may be coupled to the outer housing by a rolling weld, or the like. The flange may be coupled along a perimeter defined by the sidewalls and end walls of the outer housing. The method 700 further comprises coupling a first fluid port and a second fluid port to the cooling jacket assembly (step 712). The first fluid port and the second fluid port may be coupled to the flange, or any other location on the cooling jacket assembly configured to fluidly couple the fluid port to a channel defined by the sidewalls and end walls of the inner housing and the sidewalls and end walls of the outer housing. In various embodiments, the method 700, as disclosed herein results in an efficient and inexpensive way to manufacture a cooling jacket assembly for use in a battery system.

While the principles of this disclosure have been shown in various embodiments, many modifications of structure, arrangements, proportions, elements, materials and components (which are particularly adapted for a specific environment and operating requirements) may be used without departing from the principles and scope of this disclosure. These and other changes or modifications are intended to be included within the scope of the present disclosure and may be expressed in the following claims.

The present disclosure has been described with reference to various embodiments. However, one of ordinary skill in the art appreciates that various modifications and changes can be made without departing from the scope of the present disclosure. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments.

However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

When language similar to “at least one of A, B, or C” or “at least one of A, B, and C” is used in the claims or specification, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

We claim:

1. A cooling jacket assembly, comprising:
an inner housing, comprising:
a first inner end wall,
a second inner end wall disposed opposite the first inner end wall,
a first inner sidewall extending from the first inner end wall to the second inner end wall,
a second inner sidewall extending form the first inner end wall to the second inner end wall, the second inner sidewall disposed opposite the first inner sidewall, and
a bottom inner wall disposed along a bottom inner end of the first inner end wall, the second inner end wall, the first inner sidewall and the second inner sidewall; and
an outer housing, comprising:
a first outer end wall, the first outer end wall and the first inner end wall defining a first end wall channel therebetween,
a second outer end wall disposed opposite the first outer end wall, the second outer end wall and the second inner end wall defining a second end wall channel therebetween,
a first outer sidewall extending from the first outer end wall to the second outer end wall, the first outer sidewall and the first inner sidewall defining a first sidewall channel therebetween,
a second outer sidewall extending from the first outer end wall to the second outer end wall, the second outer sidewall disposed opposite the first outer sidewall, the second outer sidewall and the second inner sidewall defining a second sidewall channel therebetween, and
a bottom outer wall disposed along a bottom outer end of the first outer end wall, the second outer end wall, the first outer sidewall and the second outer sidewall, the bottom outer wall coupled to the bottom inner wall.

2. The cooling jacket assembly of claim 1, wherein the inner housing further comprises a flange coupled to a distal end of the first outer end wall, the second outer end wall, the first outer sidewall, and the second outer sidewall.

3. The cooling jacket assembly of claim 2, wherein the flange further comprises a first aperture and a second aperture, the first aperture in fluid communication with the first end wall channel.

4. The cooling jacket assembly of claim 3, wherein the second aperture is in fluid communication with the second end wall channel.

5. The cooling jacket assembly of claim 3, wherein a first fluid port is coupled to the first aperture and a second fluid port is coupled to the second aperture.

6. The cooling jacket assembly of claim 1, further comprising a wall extending between the first inner end wall and the first outer end wall, wherein the first end wall channel is disposed proximate the first sidewall channel, and wherein a third end wall channel is disposed proximate the second sidewall channel.

7. The cooling jacket assembly of claim 6, further comprising a first fluid port in fluid communication with the first end wall channel and a second fluid port in fluid communication with the second end wall channel.

8. A battery module, comprising:
a cell array; and
a cooling jacket assembly comprising an inner housing and an outer housing, wherein:
the inner housing defines an inner cavity and the outer housing defining an outer cavity;
the cell array is disposed in the inner cavity;
the inner housing is disposed in the outer cavity;
inner sidewalls of the inner housing and outer sidewalls of the outer housing define a channel therebetween;
a bottom inner wall of the inner housing is coupled to a bottom outer wall of the outer housing; and
the channel is configured to receive a heat transfer fluid to transfer heat to the cell array.

9. The battery module of claim 8, wherein the inner housing further comprises a flange extending outward from the inner sidewalls away from the inner cavity past the outer sidewalls.

10. The battery module of claim 9, wherein the outer sidewalls are coupled to the flange.

11. The battery module of claim 8, wherein the channel includes a first end channel disposed at a first end of the cooling jacket assembly and a second end channel disposed at a second end of the cooling jacket assembly, the first end channel in fluid communication with a first fluid port and the second end channel in fluid communication with a second fluid port.

12. The battery module of claim 8, wherein the channel includes a first end channel disposed at a first end of the cooling jacket assembly and a second end channel disposed at the first end of the cooling jacket assembly, the first end channel and the second end channel separated by a wall disposed between the outer sidewalls and the inner sidewalls, the first end channel in fluid communication with a first fluid port and the second end channel in fluid communication with a second fluid port.

13. The battery module of claim 8, wherein the bottom outer wall and the bottom inner wall are configured to transfer heat from the cell array via conduction.

14. The battery module of claim 8, further comprising a first fluid port and a second fluid port in fluid communication with the channel.

15. A method of manufacturing a cooling jacket assembly, the method comprising:
disposing an inner housing within an outer housing, the inner housing including inner sidewalls defining an inner cavity and a flange extending away from the inner cavity at an inner top end of the inner sidewalls;
coupling an outer bottom wall of the outer housing to an inner bottom wall of the inner housing, the outer housing including outer sidewalls; and
coupling the flange to an outer top end of the outer sidewalls.

16. The method of claim 15, further comprising deep drawing or bending a first sheet metal to form the outer housing.

17. The method of claim 16, further comprising deep drawing or bending a second sheet metal to form the inner housing.

18. The method of claim 17, further comprising coupling a first fluid port and a second fluid port to the cooling jacket assembly, the first fluid port and the second fluid port in fluid communication with a channel defined by the outer sidewalls and the inner sidewalls.

19. The method of claim 15, wherein coupling the outer bottom wall to the inner bottom wall includes welding.

20. The method of claim 19, wherein coupling the flange to the outer sidewalls includes welding.
